(19) United States
(12) Patent Application Publication
(10) Pub. No.: US 2025/0132449 A1
(43) Pub. Date: Apr. 24, 2025

(54) ARRANGEMENT FOR PRESSURE COMPENSATION FOR BATTERY COMPARTMENT AND ASSEMBLY METHOD

(71) Applicant: SOGEFI FILTRATION, GUYANCOURT (FR)

(72) Inventors: Florent COLLICARD, SAINT-AUBIN-DU-CORMIER (FR); Jimmy DONETTI, BAN SUR MEURTHE CLEFCY (FR); David GUYON, GUYANCOURT (FR)

(73) Assignee: SOGEFI FILTRATION, GUYANCOURT (FR)

(21) Appl. No.: 18/682,634

(22) PCT Filed: Aug. 5, 2022
(86) PCT No.: PCT/FR2022/051563

§ 371 Date: Feb. 9, 2024

(30) Foreign Application Priority Data
Aug. 9, 2021 (FR) 2108598

(51) Int. Cl. H01M 50/325; H01M 50/30; H01M 50/342

(52) U.S. Cl. CPC H01M 50/325; H01M 50/3425; H01M 50/394; H01M 2200/20

(57) ABSTRACT

An arrangement which includes a connector mounted over an opening of a battery casing, delimiting a gas flow channel. A cover is fitted onto an annular body of the connector to cover the channel in a non-sealing manner, an internal membrane provided in the channel allowing filtration. The axial fitted position of the cover, locked by a locking member, is a position in which: a tip of the cover is placed in the vicinity of the membrane which can thus be torn in the event of critical deformation towards the tip under the effect of an overpressure prevailing against the cover; and the member abuts axially against the connector. The member can deform in order to unlock the fitting of the cover when the overpressure in the channel exceeds a threshold at the time of or after the tearing of the membrane.

### FIELD

The present disclosure arises from the field of battery systems, in particular pressure compensation equipment for batteries. More specifically the invention relates to an arrangement for pressure compensation allowing emergency ventilation by movement of a cover and assembly on an electric battery/supply and an assembly method for such an arrangement.

### BACKGROUND

Systems with air evacuation plugs for batteries are known from the document U.S. Pat. No. 4,328,290A. These systems, which use the deformability of an annular seal do not allow an emergency release of a large flow of exiting gas.

The documents US 2013/0032219A1 and DE 10201913307A1 describe a pressure compensation device which includes a porous membrane to allow gases enclosed in an electrochemical module to pass. The membrane protects the interior of the module by blocking dust or water from entering. In case of instability (excess internal pressure), the membrane rises to a level such that the cover of the compensation device pierces the membrane, which allows gas to leave with a higher flow rate. However, the cover which covers the membrane has the disadvantage of having many openings for the release of air, which can accelerate a phenomenon of fouling of the membrane, with disruption of the operation of the membrane.

As described in the document DE 102019100085A1, some ventilation systems provide a cover mounted on a base firmly attached to the battery compartment. The cover carries a membrane associated with the mobile support which lifts in response to an accumulation of pressure inside the compartment. Venting to air is done according to two modes: one by default allowed by the permeability of the membrane, the other in case of emergency which opens a large section for passage so the air can escape. The accumulation of pressure beyond a fixed threshold (overpressure threshold) serves to overcome the force of the coil spring which urges the membrane and the support thereof towards a seating zone of the base.

With this type of security, if the battery continues to operate in a defective state or a state corresponding to a thermal runaway, the massive aeration may serve to limit or avoid irreversible damage to the battery and possibly severe injury, for example in case of fire. The assembly required in DE 102019100085A1 is however fairly complex.

There is therefore a need for devices of simple design, which are durable and can effectively be used for pressure compensation for batteries.

### SUMMARY

The present disclosure serves to improve the situation.

For that purpose, a ventilation arrangement for battery compartment (electric supply compartment), in particular comprising one or more batteries, is proposed where the arrangement comprises:
a connection element that can be mounted in an opening of the compartment and having an annular body extending around a central axis delimiting the channel for circulation of a gaseous fluid;
a cover for blocking the channel, where the cover is mounted on the annular body by nesting along a direction of getting closer to the base;
a gas permeable membrane or filtration part able to retain dust while allowing filtering a gaseous fluid in the channel, where the membrane or filtration part is deformable with a mobile portion that can move towards a blocking portion (belonging to the cover) in response to an overpressure from a side opposite the cover (internal overpressure), where a set portion of the channel is axially delimited between the cover and a surface of the membrane or filtration part facing the cover; and
at least one locking member locking an axial nesting position of the cover for which the cover blocks without sealing an outlet of the channel;
wherein the cover is designed and arranged, in the axial nesting position, for piercing or damaging the membrane or filtration part (which in that way is going to tear or at least no longer be a barrier as initially) when the mobile portion is moved towards the blocking portion beyond a critical movement distance, which allows at least a part of the gaseous flow to pass through said membrane or filtration part without filtration;
and wherein said locking member, which is engaged against at least one holding edge belonging to the connection element in order to axially retain the cover, can disengage from said holding edge by deformation in case of exceeding an overpressure threshold prevailing in the set portion of the channel and thus unlock the nesting of the cover.

The unlocking, which happens in response to a dangerous phenomenon of internal pressure accumulation (situation for example of thermal runaway in the compartment), advantageously supplements the tearing of the membrane in order to allow a faster pressure equilibration. By making use of a locking member, for example made of a single piece, flexibility in mounting and simplicity of assembly are possible.

The cover may be of the type not openworked and/or provided with a blocking portion without opening, such that:
an escape of air is only possible by going around or passing laterally through an external skirt of the cover; and
the cover protects the membrane preferably by forming a single axial covering part for the channel.
   Such an escape makes the blocking of the channel unsealed despite the barrier effect resulting from the blocking portion (portion which may be a full/unperforated radial portion of the cover).

In some embodiments, the cover comprises a blocking portion which extends transversely relative to the central axis, where a linear nesting movement of the cover relative to the connection element is done along a first direction.

The annular body may have an annular base allowing an axial retention against the compartment, directly or via an annular sealing element, where the annular body has a free edge (typically distal from the compartment), opposite the base. In the axial nesting position, the blocking wall is axially near the free edge or placed on the free edge, the unlocking of the nesting by deformation of said locking member allows the cover to be moved by the thrust (gas pressure—the gaseous fluid may behave typically of air, leaving or brought into the compartment via the opening) exerted on the blocking wall along a second direction opposite the first direction, because of which a withdrawal of the blocking wall far from the free edge may result.

According to a particular, the connection element is made of a single part and bears an annular sealing element, preferably housed in an inner groove of the base which opens out axially opposite the blocking portion, in order to achieve an annular seal with the compartment/housing.

The locking member or part, distinct (separately designed part) from the one or more parts making up the connection element and distinct from the cover, surrounds or is surrounded by an overlapping zone between the connection element and the cover. This makes it possible to implement a compact arrangement, with a good protection of the membrane during normal pressure compensation operation, where the cover may for example have a flat blocking portion and a covering skirt, at least partial, of the annular body.

In some embodiments, the at least one locking member lies along and/or surrounds, over more than a semi-circumference, at least one among the connection element and the cover. For example, the locking part may possibly be in discontinuous contact with the cover and in contact with the connection element near one or more holding edges. A general annular shape of the locking member may be preferred. The cover may include an annular support region with which to maintain a set axial position of the locking member in which this member penetrates into a groove area which is facing this support region.

It is advantageously allowed to reduce the number of parts necessary for assembly of the arrangement. The cover may be compact, without adding significant size in height relative to the connection element. For example, a member can be provided with a piercing end formed as an axial extension, the base of which meets the blocking portion which may be flat. Such an extension is arranged in the channel delimited by the connection element.

Typically, the cover may combine the following functions: closure of the circulation/evacuation channel by containing the thrust from the gas, support of the locking member, piercing of the membrane in case of critical situation with further a function for emergency ventilation if the thrust of the gases exceeds a pressure force threshold, which may be substantially the same as that leading to perforating the membrane or which may be higher (in this case an emergency ventilation by withdrawal the cover is reserved for more severe overpressure conditions). This combining of functions may then limit the number of parts in the arrangement. This arrangement may be preassembled.

The locking member which is distinct from the cover and the connection element, and also the possible associated means of sealing associated with the connection element, is deformable without possibility of being crushed or thinned locally (since the material of this member may be stiff like steel or other metal component), in order to unlock the nesting of the cover. This unlocking is allowed when the internal overpressure, meaning on the side of the air present in the evacuation channel, is too great. This may typically be the case at the time of piercing the membrane or under conditions encountered later.

In some embodiments, the locking is done by a part, locking member or locking part which surrounds or is surrounded by an overlap zone between the connection element and the cover, by coming to engage against the at least one holding edge.

With this arrangement, it is possible to address both:
the need to better circulate the gaseous fluid in the channel, by creating a bypass of the membrane after piercing it, which is advantageous if the loss of load related to the membrane becomes a problem;
an emergency/thermal runaway situation.
   Possibly, a suitable hardness or stiffness of the locking member may make it possible to unlock at the same time as the effect of bypassing the membrane which was just pierced.

The arrangement serves to overcome a disadvantage related to the loss of load, in case of abnormal overpressure, while also remaining a simplified design. The locking part serves to lock, typically mechanically, the closed position of the cover while allowing the ventilation by deformation thereof, under overpressure conditions corresponding to a need for emergency ventilation. The deformation may be an elastic deformation, as necessary used during a nesting movement, before locking which can result from an elastic restoring force towards the default conformation of the locking part. The deformation, typically in a transverse plane, produced during assembly or nesting (in response to a thrust force) may be repeated in response to the traction force insignificant overpressure situation under the cover, which authorizes the emergency ventilation.

Advantageously, the locking may be allowed by using a single part/piece making up a single locking member, which comes to engage radially inward under a corresponding holding edge. Whether the implementation of the locking is done by such a piece or by a functionally equivalent locking part, it is understood that the locking means may be selectively assembled otherwise than in the sealed zones, preferably by earlier assembly of these locking means on the cover. Sealing parts may be mounted against remote attachment regions, typically provided on the connection element: implementing an assembly without any interface between the sealing zone(s) and the holding zone for the lock is allowed.

The arrangement may be assembled by obtaining the locking. A preassembled design, without mobility of the locked cover, allows the arrangement to be able to effectively block the opening and maintain the integrity of the membrane (near piercing means belonging to the cover), in an environment subject to vibrations. This is especially the case when the battery compartment is mounted in a motor vehicle, for example in an automobile or other rolling equipment.

In some implementation options, the porous membrane is designed in order to guarantee the seal against oil, water and dust.

The membrane may be of hydrophobic material and/or form a watertight barrier.

Optionally, the at least one locking member is supported by the cover, for example by being able to deform with a radial travel of engagement segments spaced/separated from each other and distributed into branches or halves exerting a tightening function on a portion of the connector/connecting element inserted between these branches/halves by the longitudinal nesting action.

The at least one locking member is for example mounted on the cover in order to follow both:
the linear movement corresponding to the nesting, along the first direction;
only the reverse linear movement in case of emergency ventilation, along said second direction.

According to a detail, the cover has a tubular portion able to house on the inside (therefore surround) an insertion portion provided in the connection element, where the insertion portion has for example the shape of an annular projection in the connection element.

Typically, the locking member, supported by the tubular/annular portion of the cover, is adapted for coming to engage, preferably from the bottom, against at least one holding edge formed in an insertion portion belonging to the annular body, in order to lock the axial nesting position of the cover.

In some embodiments, this locking is implementable only in an overlapping position of the tubular portion around the insertion portion. The locking member may extend or be inserted (be inserted laterally) in at least one empty space or window of the tubular portion, in order to exert a tightening action against the insertion portion. The locking member may be (elastically) deformable by radial outward deformation.

In some embodiments, the locking member extends annularly around the central axis. The locking means may consist of a single unitary element, forming a single locking member.

In some examples of construction of the locking member, one or more of the following provisions are intended:
the locking member is made as a single piece.
the locking member is made of a mineral material, for example a metal, without plastic or silicone material (non-elastomer for example).
the locking member is made of a non-stretchable material.
the piece can be deformed without folding, meaning by retaining the geometry/general geometric shape thereof, preferably by modification of the spacing between the two ends of this part which are neighbors to each other.
the locking member is elongated/long, for example wire type, and extends between an inner circumferential edge and an outer circumferential edge, where the locking member is deformable without variation of the width defined/delimited between the inner circumferential edge and the outer circumferential edge.
the shortest dimension of the locking member is a height measured along a direction parallel to the central axis, where the height is for example less than or equal to 8 mm.
the locking member is flat, preferably arranged substantially in a plane perpendicular to the central axis.
the locking member is able to tighten around the portion of insertion through the tubular portion.
windows are provided with a delimitation by axial rims, on the cover, where the locking means or member(s) sit/rest axially on at least two of these axial rims.
the at least one locking member consists of a staple which has two tightening branches connected to a single intermediate portion.
the locking member is symmetric about a plane.
the locking member is made from a metal strand having a general annular shape with a single lateral outlet located between two branches or halves of the locking member.
the locking member is a composite material, which could have a load of glass fibers and/or mineral particles, preferably without including metal.
the locking member has two branches that can separate, with two free ends delimiting an access opening passage of set width.
the locking member includes one or more engagement segments, each radially mobile outward or inward in case of application of the force acting against an elastic restoring force restoring the member to a tightening configuration.
the separation between two contact regions between the locking member and the connection element, which are distributed on the two branches, may be greater than the set width.
the locking member extends in a plane which is transverse to the central axis, preferably perpendicular to the central axis, and optionally perpendicular to the direction of nesting of the cover.

The characteristics disclosed in the following paragraphs may, optionally, be implemented independently of each other or in combination with each other:
the insertion portion is an annular projection, axially projecting from the base, which inserts linearly in the tubular portion designed as a skirt (typically outside skirt) of the cover.
the skirt of the cover is provided with at least one notch or window for receiving an engagement segment belonging to the locking member.
the locking member is accessible from the outside of the cover, in the preassembled state of the ventilation arrangement.
the locking member is mounted in an inner volume of the cover.
the connection element has a holding edge/engagement rim that is annular and/or distributed in at least two segments separate from each other (holding edge under which the locking member comes to engage).
each holding edge extends in a concentric annular region about an annular support region surrounding or surrounded by this holding edge.
the annular support region belongs to the cover in order to support the locking member.
the locking member is held secured to the cover by the annular support region, both in a first configuration for tightening with contact against the connection element (corresponding to a locking configuration of the nesting) and in a second configuration of tightening compatible with an un-nesting of the cover relative to the annular body.
the cover further has a support part connected, preferably axially, to the blocking portion, for bearing the locking member.
the support part comprises a ring or peripheral portion laid out for bearing the locking member.
the support part includes a pointed projection, piercing member or toothed termination with which to pierce/perforate the mobile portion of the member.
in the support part, means for displacement or tearing of the membrane are provided, preferably in the form of an end projecting axially relative to the ring, by projecting along a direction going opposite the blocking portion.
the locking member extends annularly by following circumferentially along an inner surface of the annular body belonging to the connection element.
the locking member serves to retain the cover axially in the nested position by coming to engage against at least one inner relief included in the inner surface of the annular body.
the annular body may be made of a single piece of stiff material.
the annular body can be inserted partially in an annular space which is provided in an inner volume of the cover, by inserting it between a skirt of the cover and a central piercing stem belonging to the cover.

According to another aspect, a use of the deformable member is proposed for locking the nesting of a cover in order to block an opening intended in the battery compartment, in particular comprising one or more batteries, while also allowing an emergency ventilation in case of overpressure of gases in the compartment. According to this use, the deformable member is arranged for entering into engagement against an axial stop surface belonging to one connection element forming a channel for circulation of gaseous fluid blocked by the cover, with the detail that:
the connection element is mounted in said opening and supports a gas permeable membrane that can retain dust, where the membrane serves to provide filtration of gaseous fluid in the channel (all the flow thus channeled having, for example, to pass through the membrane), the membrane is deformable with a mobile portion moving towards a blocking portion of the cover, in response to an overpressure on an opposite side from the cover, and a set portion of the channel is delimited axially between the cover and the surface of the membrane across from the cover, while being surrounded by an annular body of the connection element;
the cover is mounted on the annular body by nesting, along a first direction, parallel to the central axis, by implementing an unsealed closure of an outlet of the channel; and
the locking member locks the axial nesting position of the cover;
with the detail that the cover serves to pierce or damage the membrane when the mobile portion is brought closer to the cover beyond the critical movement distance, which allows at least a portion of the gaseous flow to pass through said membrane without filtration, and that the locking member is deformable, preferably elastically deformable, to:
   exert radially a restoring force against a surface of the annular body, in order to allow at least one contact of said member with the connection element; and
   unlock the nesting of the cover when, subsequent to piercing or breakdown of the membrane, the overpressure governing in the set portion of the channel exceeds a threshold allowing overcoming said restoring force, whereby the cover may be pushed back along a second direction opposite to the first direction.

The locking member may consist of one annular piece previously assembled onto the cover. Independently of the design thereof in one or more parts, this membrane may be arranged so as to surround an overlap zone between the connection element and the cover, or to be surrounded by this overlap zone.

According to another aspect, a method is proposed for assembly of the previously presented ventilation arrangement by using the connection element that can be mounted in an opening of a battery compartment, the connection element delimiting the channel for circulation of gaseous fluid, where the method comprises the steps consisting essentially of:
arranging the membrane transversely in the annular body in order to allow a filtration of the gaseous flow moving in the channel;
mounting the cover on the annular body by nesting towards the membrane, such that the blocked portion covers an axial outlet of the channel and covers the membrane where a pointed or cutting end included in the cover is placed facing the membrane;
locking the axial nesting position of the cover by at least one locking member;
where the at least one locking member is placed on the cover before nesting, and where the nesting is done such that the at least one locking member:
comes to engage against at least one holding edge formed laterally on the annular body; and
remains deformable in order to allow unlocking the nesting of the cover when the overpressure on the gaseous fluid side present in the set portion of the evacuation channel exceeds the threshold.

This assembly is simple to do and may be quick, since the membrane can be welded in advance on an annular edge or inner shoulder of the annular body. A single locking member mobile with the cover may be used for the locking and unlocking actions. An attachment of the arrangement on the compartment may be implemented before or after nesting, for example by a bayonet connection with at least partial insertion of the base through the opening of the compartment.

According to a particular, the at least one locking member is one piece placed on the cover before nesting, by spreading two opposite ends of said piece that is deformable, before tightening an annular support region belonging to the cover.

According to a particular, the locking by a locking member is produced in a preassembled ventilation unit which does not yet cover the opening of the battery compartment. The arrangement may be transported, packaged and delivered robustly, without risk of detachment of the cover, and serves to limit the number of steps for placement of the arrangement on the battery compartment. A simple screwing or bayonet connection may serve to get the seal by means of the joint of the base, whereas the cover is going to remain in its unsealed blocking configuration, fully nested on the connection element.

### BRIEF DESCRIPTION OF THE DRAWINGS

Other characteristics, details and advantages will appear upon reading the following detailed description, and the analysis of the attached drawings, on which:

FIG. 1 shows, before assembly thereof, two parts making up a ventilation unit which can be mounted directly on a wall of a battery compartment, in order to block an opening in this wall, where the cover part is shown from below with the locking member assembled on an annular groove, radially outside the stiff ring included in the cover.

FIG. 2A is a longitudinal section view of the ventilation arrangement from FIG. 1 in a preassembled state with a projection from the connector projecting axially in order to be positioned between an external skirt of the cover and a locking member placed on the inside in the cover.

FIG. 2B is the same view as FIG. 2A, showing an example of pressure compensation with a circulation of a gas flow through a membrane, in a channel blocked in a way not sealed by the cover.

FIG. 3 is a transverse section view of a ventilation arrangement variant, serving to illustrate an example of engagement between a locking member borne by the cover and retention services provided by a connection element with generally annular shape.

FIG. 4 is a perspective view of a part forming an assembly support for the cover.

FIG. 5 shows an example of assembly of the ventilation unit, which is here similar to the one from FIG. 1, on an outer surface of the wall of the battery compartment.

FIG. 6 shows, through two successive views of a ventilation arrangement according to the variant from FIG. 3, an examplary removal of the cover in response to a thrust by hot gases on this cover, with a thrust force which overcomes the elastic restoring force of a tightening staple making up the locking member.

### DETAILED DESCRIPTION

Several examples of nonlimiting embodiments are disclosed below in detail. In the various figures, identical references indicate identical or similar elements.

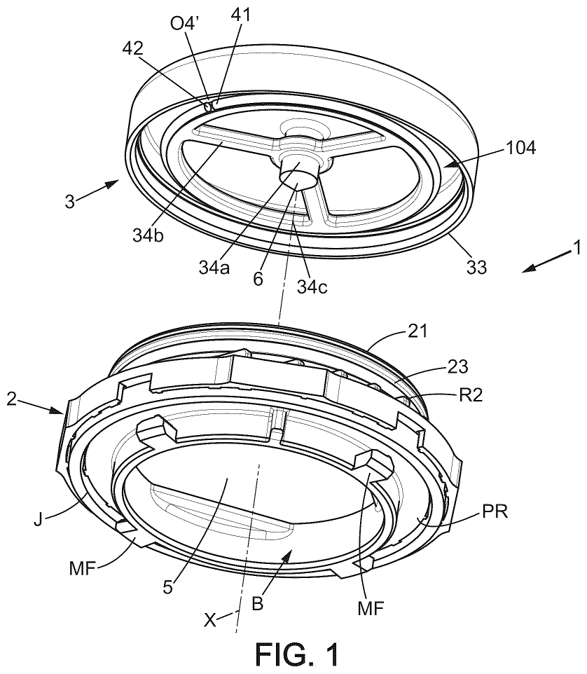

Referring to FIGS. 1, 2B, 5 and 6, a ventilation/pressure compensation unit is shown which can be delivered as a preassembled unit, ready to block an opening O of a battery compartment by typically being mounted on the side of an external surface of a shell or plate of the compartment P. In the following, this preassembled unit is called ventilation arrangement 1. In preferred options, the arrangement 1 has a supporting part including or consisting of a connection element 2 provided with attachment means MF, for example formed like insertion/retention tabs, for holding it in position on the battery compartment. The attachment means MF may be provided in a base B of the connection element 2, extending from an inner part which can optionally be inserted inside the battery compartment. The connection element 2 may be composed essentially of a rigid connector, optionally provided with a joint J mounted or recessed on this connector.

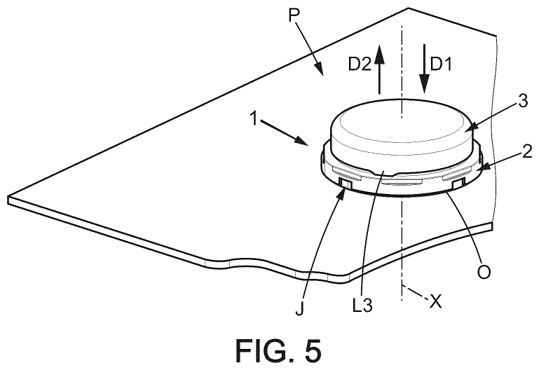

Referring to FIG. 5, the connection element 2 may include an inner part (inserted in the battery compartment) not visible in the assembled state and an outer part of generally annular shape. The connection element 2 has an annular body 20 open at both axial ends thereof and which can optionally allow tightening a joint J against the battery compartment. As shown in FIGS. 1 to 2B, 4 and 6, the annular body 20 corresponds to a ring or similar tubular member, which extends longitudinally around a central axis X, to a free edge 21 axially distal from the opening O.

The attachment means MF may be included in a part constituting the annular body 20 of the connection element 2. More generally, the connection element 2 may have a body 20 which is stiff, injection molded in a single part, and including attachment means MF provided in a connection part corresponding to the base B.

On FIG. 1, it can be seen that the base B may have an annular radial portion PR which includes or forms the bottom of a groove oriented towards the compartment with which to receive an annular joint J. The groove G1 may extend axially under an attachment part engaging with the cover 3. The joint J has a height that is typically larger than the depth of the groove G1. More generally, the joint J may project downward (here towards the compartment) by thus presenting a surface which extends outside of the groove G1 and able to bear axially against the battery compartment. The annular surfaces delimiting the groove G1 may, each, have ribs or projecting reliefs for retaining the annular joint J. These relieves or ribs, distributed spaced along the circumferential direction, project radially towards the inside of the groove G1.

Bayonet connection means, with tabs projecting radially outward, may constitute all or part of these attachment means MF. Here, for example, the tabs engage with a border of the opening O of the compartment having several specific radial slots distributed in the same way as these tabs. A rotary movement may allow fixing the position of the connection element 2 with an alignment relative to a center of the opening O. In some variants, the connection is done by screwing or with any type of rotation for axially fixing the connection element 2. An attachment with deformation of a joint with anchoring function may also be used, as appropriate without rotation.

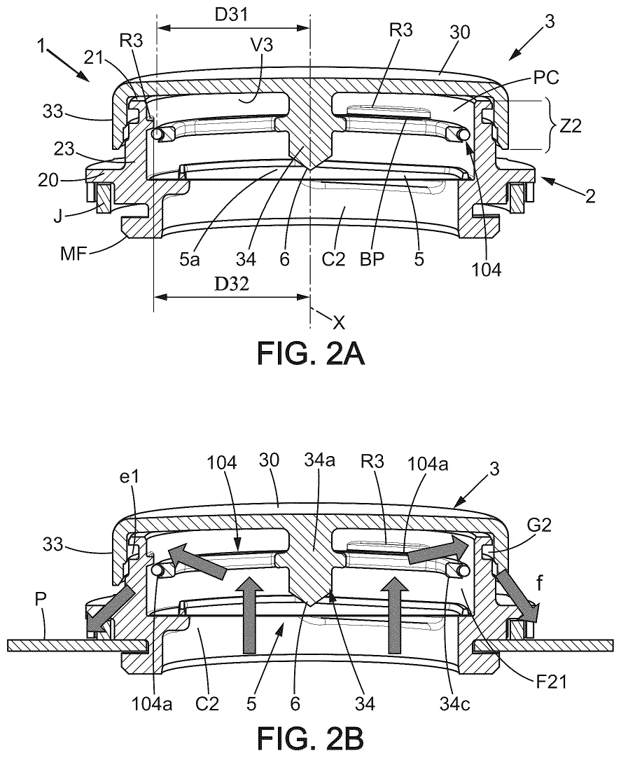

The bayonet connection means or, more generally, attachment means MF may be arranged radially closer to the central axis X than the groove G1 is. The outer lateral surface of the base B or base of the arrangement 1 joins an annular upper surface of the base B, visible on the FIGS. 2A, 3 and 4 which belong to radial portion PR. The annular body 20 has a projection projecting axially from the radial portion PR.

As shown in particular in FIGS. 1, 2A and 2B, this projection 23 may extend the base B axially such that the base B and the projection 23 delimit an annular (shared) inner surface F21 of the connection element 2. More generally, the arrangement 1 typically forms at least one conduit, here, by the connection element 2. The annular body 20 then delimits a channel C2 for evacuation of air connecting with the inside of the compartment via the opening O.

In the nonlimiting example from FIGS. 1 to 6, at least one membrane 5 or a suited filtration part is provided, which is arranged transversely relative to the central axis X. Here, the membrane 5 filters the air passing through the channel C2 which serves to retain dust. The membrane 5, gas permeable, filters gaseous fluid in the channel C2, while deforming under the action of a significant pressure of the gas flow leaving the battery compartment. Referring to FIGS. 2A and 2B, a typical position in the normal operation of the membrane 5 is shown as an illustrative and nonlimiting example, with an exiting flow f which is moderate and passes through an exhaust zone el which may be tightly delimited in the overlap zone Z2 between a portion or projection 23 of the connection element 2 and the cover 3 held in a blocking position, here an axial blocking position relative to the upper opening out of the channel C2. More generally, it is understood that the arrangement 1 is provided with means for blocking the channel C2, non-hermetically to exiting gases. The circulation of these exiting gases is shown by solid arrows in the scenario from FIG. 2B. As can be seen, a peripheral/on the nesting zone exhaust path may be created.

A set sub-portion PC of the channel C2 may be axially delimited between a blocking portion 30 belonging to the cover 3 and the membrane 5, for example on the side of the surface of the membrane directly facing an inner surface (battery compartment side) of the blocking portion. The membrane 5 has a mobile portion 5a that can move towards the blocking portion 30 in response to an overpressure on an opposite side of the cover 3.

On the cover 3, a rod, for example a central rod, or any other part suited for piercing or removing the filtration function from a part of the membrane 5, may be provided in order to compensate an excessive pressure differential. This actuating means for clearing (in channel C2) a passage without gas filtration by the membrane 5 is here a stiff element which is fixed relative to the remainder of the cover 3. Such a stiff element has for example the shape of a column 34a or axial extension ending in at least one end 6 typically pointed, blade or end suited for piercing the filtering fabric or layer of the membrane 5.

This piercing is here done in the mobile portion 5a which can be lifted until reaching the end 6 which corresponds to a movement beyond a critical movement distance. A passage path or opening 05 is here created for example away from the linking edge (possibly by welding in an annular zone) with the connection element 2. This could allow at least a portion of the gas flow to pass without filtration through the membrane 5 or similar filtration part.

An external shoulder of the annular body 20 could be provided with which to connect external surface F22 of the projection 23 to an external surface of the base which may have notches or slits, distributed for example in the same angular sectors as the attachment means MF, which may help the installation of the joint J and/or make it easier for material to deform in the zones of the plate P of the compartment axially constrained by/from the interior by the attachment means MF. Flats 29 or other relief making a hold easier, optionally by a tightening/loosening tool, may further be distributed on the lateral surface of the base B which is radially offset to the outside relative to the projection 23 because of the outer shoulder of the body 20.

In the nonlimiting example from FIGS. 1 and 2B, it is understood that the joint J may bear on an annular seating zone provided on the compartment, around the opening O, typically without penetrating inside the compartment. This joint J may be an annular joint, for example of elastomer, coming into contact axially with the compartment, over an outer surface thereof. Here, one or more joints are shown which are recessed or integrated in the connection element 2, in order notably to implement a sealed annular contact in a peripheral zone located around the circumference of the opening O, for a contact sealed here against gas. For example, the joint J borne by the base B of the body 20 is axially constrained against the plate P of the battery compartment that includes the opening O. Of course, a joint could also be mounted directly on the plate P, for example on a suitable groove zone, near which an axial and/or radial tightening action might be exerted on the joint by the base B, for a configuration locked using the attachment means MF.

The joint J may be mounted by tightening on the annular groove G1 provided in the base B of the connection element 2, where the joint J belongs to a preassembled unit of the type, for example, shown in FIGS. 1-2B and 6. The opening O may be circular or any suitable shape. The arrangement 1 forms a conduit, here, by the connection element 2. The annular body 20 then delimits the channel C2 for evacuation of air connecting with the inside of the compartment via the opening O. The compartment itself may enclose battery modules, such that the plate for the compartment P is not in direct contact with the liquid or fluid substance participating in the electrochemical reactions.

The base B may correspond to an annular end of the body 20, opposite the annular free edge 21 of this body 20. The arrangement 1 is provided with the cover 3 assembled on the connection element 2 and with which to block the opening O, here in an unsealed nested position, typically with an overlap between an outer skirt 33 of the cover 3 and the annular projection 23 formed by the body 20 opposite the base B. Because of this overlap, the free edge 21 extends into an inner volume V3 of the cover, delimited by the skirt 33.

### Embodiment of a Passage for the Gases in Normal Operation

The connection element 2 whose bottom or base B in a socket shape allows the attachment to the battery compartment, may form below the base B a cylindrical shape or another tubular shape compatible with the formation of an exhaust path el, which may be annular. The annular projection 23 here includes an outer groove G2 opening out laterally towards the outside and which is not filled by a sealing element or, alternatively, filled by a sealing element which has one or more discontinuities allowing air to pass from the PC portion to the outside of the channel C2 (beyond the cover 3).

The cover 3 may have a simple design, for example without support or relief for retaining a joint of any kind. Here, the cover 3 has a main blocking portion 30 which can correspond to a bottom part, from which a tubular, lateral wall extends forming a skirt 33 of the cover 3. As can be clearly seen in FIG. 2B, an exhaust path may be provided along this outer skirt making the blocking unsealed despite the gas barrier effect of the blocking portion 30.

Referring to FIGS. 1, 2A-2B, 5 and 6, the cover 3 has one or more grooves with which to support at least one locking member 4, 104, in a region which does not interfere with either the circulation of gases through the membrane 5, or with the mobility of the membrane 5.

As can be seen in FIGS. 2A and 2B, the skirt 33 of the cover 3 may be thick away from the annular edge thereof, with a shoulder in the annular inner surface thereof, or in any case delimiting an inner circumference which varies for a flared effect. This allows a first centering of the skirt 33 without friction, when the cover 3 starts to cover over the annular projection 23. The geometric correspondence and the small clearance, for example less than 5 mm, between the cover 3 and the projection 23 allow guiding. This guiding/first centering avoids placing the cover so that is inclined relative to the central axis X and prevents accidental piercing of the membrane 5 during nesting. Next the cover 3 is completely nested in order to have the blocking portion 30 closest to the free edge 21 or in contact (typically discontinuous) with this free edge 21.

### Holding the Cover in Position

The cover 3 may be fixed relative to the connection element 2 without an axial spring or any part allowing a translational or rotational degree of freedom. In some options, an anti-rotation effect is also obtained by the action of a locking member 4 or 104 typically recessed on the cover 3 and coming to engage on a retaining region provided in the connection element 2. More generally, such a member 4, 104 serves in practice to block an accidental withdrawal of the cover 3, for example in case of a jerk when the battery compartment is loaded on board a motor vehicle. In the nesting direction of the cover 3, a stop thereof may be allowed when tabs L3 formed by the skirt 33, projecting axially opposite from the transverse blocking part 30, come to stop against an annular external shoulder of the connection element 2 as can be seen for example in FIG. 5.

Independent of the fact of mounting the cover 3 on the connection element 2 in advance, it may be provided that the unsealed blocking position of this cover 3 be locked with a locking action involving a greater resistance than that of any friction between an inner surface of the cover 3 and the fixed part on which the membrane 5 is mounted.

More generally, a locking of the nesting position of the cover 3 is achieved using a separately designed sealing means J. Typically, this element has no role in getting a sealed contact while axially blocking the position of the cover 3. Here, this element takes the form of a locking member 4, 104, preferably made of a single deformable piece with a spring or elastic restoring force towards a tightened position that is exerted for maintaining a part of the cover 3 at the same level as a holding edge BP provided on the connection element 2. For example, the locking member 4, 104 may have the shape of a clip, a staple hook or any other structure suited for tightening. A hooking along the circumference of the annular body 20 may be achieved by distributing axial stop zones in at least two or three distinct angular sectors, preferably by using a shared piece for making these contacts.

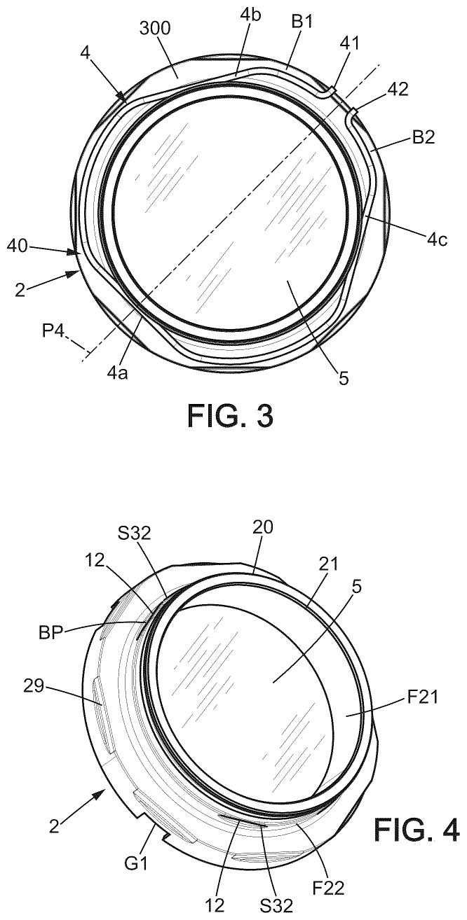

In an embodiment, the locking member 4, 104 is symmetric about a median plane, by delimiting a tightening region with contact, between two branches B1, B2 distributed on either side of this plane of symmetry P4 (for example, see FIG. 3). The part forming the member 104 in FIG. 1 may have such a symmetry by having an O shape bent from one side. Such a path may be deformed radially by going away from or towards the bottom of the support groove, here a continuous annular groove which carries this member 104. In some variants, the locking member is asymmetric. The locking member could have one branch that is more deformable than the other and/or which is folded more towards the inside (towards an inner central zone around which this member extends) than the other branch.

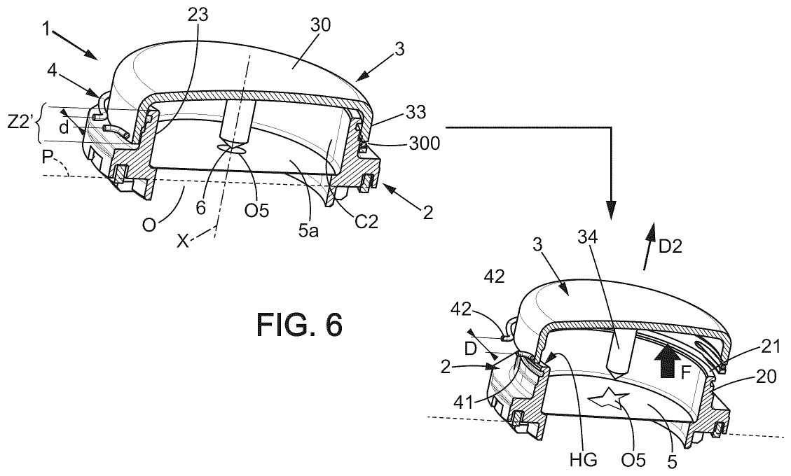

The axial nesting position of the cover 3 shown for example in FIG. 1 or to the left in FIG. 6 may be locked in a preassembled state of the ventilation unit. In some options, a rotational indexing of the cover 3 relative to the body 20 is made possible by a guide using an indexing relief; this may be the case when the mobile portion 5a of the membrane is not centered relative to the axis X. For example, in the case of FIG. 4 the fluting or projecting relief complementary to longitudinal recesses placed on the connection element may allow aligning (in the same angular sectors), grooves 12 of the body 20 and, in the cover 3, recesses or windows 300 for access to these grooves 12.

The locking member 4, 104 is here borne by the cover 3 and may have a flat configuration, without possibility of translation parallel to the central axis X relative to the cover 3 after having been assembled in the support region.

Once the cover 3 is nested, the locking member 4, 104 may surround an overlap zone Z2 or Z2′, visible for example in FIG. 2A or FIG. 6 between the connection element 2 and the cover 3. The annular structure of this member 4, 104—here unclosed with two halves or branches B1, B2 having free terminations or ends 41, 42—serves to place the locking member 4, 104 around the support region, belonging to the cover 3 which is at least partially openworked and/or hollow.

In the example from FIG. 1, the locking member 104 is tightly surrounded by an inner surface of the annular body 20, provided with reliefs R3 forming rims for holding, axial hooking/retention of the cover 3. The member 104 is for example housed in a groove shaped recess as shown in FIGS. 1 to 2B, where this recess is formed on a ring 34c of an interior support part 34, which extends in the channel C2 and more specifically in a portion PC of this channel C2 from the blocking portion 30.

The support region may be a circumferential region, preferably with at least two reinforcements, recesses, notches, windows or equivalent receiving zones formed externally on the support region. Referring to FIGS. 4 to 6, presence of openings or windows 300 makes accessible an insertion part formed in the connection element 2, here housed inside relative to the cover 3, which allows portions reentrant/projecting towards the interior of the locking member 4 to be inserted in these openings or windows 300 and come to engage against at least one axial stop surface S32 belonging to the connection element 2. The surface S32 may correspond to the delimitation of a notch, a groove, resulting from a structure with relief and/or changing section provided on the connection element, in the area of the overlap zone Z.

In this type of option, it is understood that the locking member 4, axially retained by the cover 3 (for example by blocking between axial and limitations of the one or more recesses/Windows 300) may then engage under a rim or holding edge BP provided on the connection element 2 which suffices to prevent the withdrawal of the cover 3 and locking the nested position of this cover 3.

### Unlocking in Addition to Membrane Piercing

The locking member 4, 104 has a deformability which can allow releasing the tightening of the connection element 2, when the cover 3 is subject to a significant thrust from the gases, which are for example hot gases HG present inside the battery compartment. Referring to FIGS. 2A-2B and 3, it can be seen that the locking member 4, 104 in staple form allows tightening only when elastic restoring force of the halves or branches B1, B2 suffice to establish a hold under the one or more retained reliefs/surfaces R3, S32 provided on the connection element 2, in particular provided on an insertion point coming to be housed in the inner volume V3 of the cover 3.

When the overpressure from the side of the air/gas present in the evacuation channel C2 has already served to pierce the membrane 5 and further exceeded a threshold, at least one of the two branches B1, B2 is going to separate from the other, such that the separation or distance D between the ends 41, 42 of the locking member 4, 104 is going to be expanded relative to the nominal distance corresponding to the usual configuration of the locking member 4 as shown for example in FIG. 6. This separation D is sufficient so that the axial stop force against the holding edge BP is no longer sufficient to block the cover 3 which is pushed back along the direction D2 (visible in FIGS. 5-6) and corresponding to a movement of separation of the cover 3 relative to the plate P of the compartment where the opening O is provided.

Once the cover 3 disengages/separates along the direction D2, the gas flow F which is going to be able to escape from the battery compartment by an opening of the channel C2 is then going to be high by comparison with the moderate flow f able to escape in the blocking position of the cover 3.

A slit substantially circular shape of the locking member 104 may also be used, without intermediate part connecting two branches. In this case, a deformation by radial travel remains possible with the freedom of movement allowed by spreading, near the slit (see the separation, O4′ on FIG. 1) between the ends 41, 42 of the locking member 104.

Now, embodiments using a member 4, 104 for locking the cover in position are described, which may correspond to a staple provided with two halves, segments or branches B1, B2 in order to allow tightening. The two branches B1, B2 are for example connected to a single intermediate portion 40 and the placement of the member 4, 104 typically done as a single part, may be quick.

### First Example of Integration of the Locking Member

Now, a first embodiment of the arrangement is going to be described in more detail with reference to FIGS. 1, 2A and 2B. Here, the locking member 104 is mounted on an inner circumference of the cover 3, for example by following the inner surface of the skirt 33. The member 104 has a general ring shape with a slit or opening O4′ which separates two terminations or ends 41, 42. The member 104 may constitute a retaining ring or circlip, preferably with the detail of having a section that is not flat. Typically, the section (in profile view) of the retaining ring or similar part forming the member 104 is round, which makes unlocking easier. The locking member 104 may have a metallic strand structure, possibly with a rounded section at least in the parts thereof in axial contact with the retaining reliefs R3 where these reliefs R3 are typically provided in the connection element 2.

The support/attachment region, formed in a support part 34 belonging to the cover 3, is annular and near the skirt 33. The support region for the locking member 104 is separated radially (towards the outside) from the central rod or column zone 34a of the part 34. Here, the part 34 of the cover 3 forms a bracing device, which allows (here by the braces 34b) making a groove which is across from an internal surface of the skirt 33 of the cover. An annular space for receiving the annular projection 23 is thus created. This annular space is for example delimited:
inwardly by a peripheral ring 34c for the support part 34, supported by the braces 34b and the column 34a;
and outwardly, by the outer surface of the skirt 33.

The locking member 104 has the shape of a generally flat part and for example designed without edge or rim extending on the lateral surface of this member 104. This part fills the external groove provided on the external circumference of the ring 34c. With an annular shape in a plane perpendicular to the central axis X, the locking member 104 extends in the annular space while leaving an annular passage for the projection 23 forming the insertion portion of the connecting element 2. In FIG. 2A it can be seen that the reliefs R3 extend a radial distance D32 from the central axis X coinciding here with an axis of symmetry of the cover 3. The support part 34 has an outer lateral surface, provided on the ring 34c in this nonlimiting example, which extends to a radial distance D31 from the central axis X which is slightly smaller than the radial distance D32.

The locking member 104 occupies an annular space, radially between the lateral outer surface of the support part 34 and the inner surface of the body 20, while extending beyond the distance D31 having an outer circumference which extends along the inner surface of the body 20, for example on over 80 or 90% of the circumference of this body 20. In a configuration more contracted/flattened inward, this member 104 may slightly separate from the inner surface F21, at least in the area of the reliefs R3.

It is understood that the locking member 104 may deform by shrinkage which is typically already been obtained for the placement of the cover 3 by nesting. Here, the staple 104 has already been deformed once with the shrinkage of the annular circumference thereof before occupying the locking position there (deployed/more expanded configuration).

Return to the deployed configuration is made easier by the circular or continuously curved nature (without roughness which could add to a retaining force), as seen in cross-section, of the wire or strand which could make up the locking member 104. In some options, this freedom from roughness may be met only in the engagement segments 104a.

In profile view, the locking member 104 has a round section or other suitable section which has a progressive narrowing going towards the inner surface of the annular body 20 and a progressive narrowing also progressing while approaching the side of the bottom of the groove of the ring 34c. A relatively flat ring 34c was shown. However, in some variants, the member 104 may be borne by a longer tubular portion, which could allow eliminating the column 34a.

With this type of structure for the cover 3, a staple or similar locking member 104 is placed recessed on the ring 34c forming the supporting region, which can come to engage axially against one or more internal reliefs R3 of the connection elements 2. The locking member 104 may be a metal part or another material (intrinsically) stiffer than the joint J, deformed and moved radially inward during the placement of the cover 3 by nesting, for example by being locally pushed/compressed by the projecting relief R3 uniformly distributed in different angular sectors around the ring 34c. This may cause a slight change of configuration, more compact, with the ends 41, 42 which come closer by reducing the separation or slit O4′.

When the cover 3 is placed with an unsealed blocking of the channel C2, the locking member 104 is located immediately under the relief R3, such that by elastic restoring force or restoring towards a default geometry, the locking member 104 returns to the initial shape/configuration thereof and may axially engage under the relief R3. The locking of the cover 3 is done, typically, with contacts against the connection element 2 distributed in several engagement sections or segments 104a (here curved sections, which could be a continuous curve in the annular/circular part and slit constituting the member 104). Under emergency circumstances, ventilation is possible because the locking member 104, which is reversibly deformable, has the possibility of again taking a more compact configuration if the force exerted on the cover 3 exceeds a threshold for allowing this deformation.

In this example, it is understood that the deformation may be distributed over most of the length of the locking member 104: it is not a matter of a localized deformation which could correspond to a folding. The deformation allowing the ventilation by movement of the cover 3 here corresponds instead to a contraction and it is the elastic restoring force, here radially outward, of the locking member 104 which serves to guarantee the locking.

In case of thermal runaway and/or abnormal conditions leading to an overpressure in the channel C2, after piercing of the membrane 5 or at the moment when the gas was just released because of the piercing, the locking member 104 may remain secured to the cover 3, while resting engaged in an annular groove or in recesses forming the support region for this member 104.

The locking member 104 is deformable with a possibility of disengaging from the one or more holding edges and axial stop surfaces (under the relief R3) beyond an axial force threshold. In case of overpressure under the cover 3, it is understood that the traction force concentrated near the contact zone with the one or more holding edges BP is going to exceed a threshold for overcoming the elastic restoring force exerted outward on the engagement segments which extend slightly under the reliefs R3, such that a loosening facing the projection 23 will be obtained by simple deformation of the member 104, which is more easily deformable than the stiff body 20 or the stiff cover 3.

Referring to FIG. 2B, it is understood that the membrane 5 is going to first be torn/pierced before sufficient overpressure effect may occur for deforming the member 104 until disengaging it from the internal reliefs R3. While the overlap zone Z2 around the insertion/projection portion of the connection element 2 could form a limited exhaust path for the gases, under normal operating conditions of the pressure compensation, the piercing may also lead directly to an unlocking which serves to reduce or eliminate the overlap zone Z2, where the cover 3 is moved farther from the pierced membrane 5. If a staple forming the locking member is more difficult to deform, the unlocking threshold could be reached in a subsequent emergency situation, since the membrane piercing could turn out to be sufficient for a return to pressure equilibrium, without necessarily unnesting/moving the cover 3.

According to this first embodiment, the withdrawal of the cover 3 occurs once the locking member 104 starts to deform radially inward by contracting radially, typically with a reduction of the spacing O4′. This may happen with the supply of pressurized gas resulting from a tear in the membrane 5. Before the tear, meaning with an intact membrane 5 and/or without bypass of the filtration, the locking member 104 remains in a position held axially against the reliefs R3. In fact, the overpressure is limited by the loss of load near the membrane 5, such that the overpressure acting in the direction D2 and governing in the portion PC is not sufficient for exceeding the threshold allowing the deformation.

More generally, it is preferable to see the membrane 5 impaled on the cover 3 for example near a pointed end 6, before allowing sufficient gas flow to pass corresponding to an emergency situation during which the cover 3 is going to be ejected. For example, a deformation or elasticity parameter of the mobile portion 5a of the membrane 5, a stiffness parameter of an elastically deformable part constituting the member 104, and also the nominal distance between the mobile portion 5a and the end 6 are chosen in order to allow piercing before unlocking of the nested configuration of the cover 3.

In this example, the annular joint J is placed lower than the cover 3 and lower than the membrane 5. In case of thermal runaway and/or abnormal conditions leading to an overpressure in the channel C2, the locking member 104 may remain secured to the cover 3 while remaining engaged in a circumferential groove shaped lateral recess provided in the support part 34, designed here as an inner central extension connected to the blocking part 30.

### Second Example of Integration of the Locking Member

Now, a second embodiment of the arrangement is going to be described in more detail with reference to FIGS. 3, 4 and 6, with a different integration of the locking member 4. It involves a ventilation arrangement 1 analogous to the case shown in the preceding figures, with the same type of attachment by the base or bottom part thereof provided in the connection element which delimits the channel C2. The connection element 2 will therefore not be described again, except for specific parts having some differences.

Here the locking member 4 is mounted on a periphery of the cover 3, for example around the skirt 33. The member 4 has a general U or C shape. A shape of the member 4 with a full loop is also allowed, in some options, to the extent where a deformation is possible between two segments or branches B1, B2 of the member 4.

For an arrangement such as shown on FIGS. 3 and 6, it can be seen that the locking member 4 surrounds an overlap zone Z2′ between the connection element 2 and the cover 3. The support/attachment region, formed in the skirt 33, surrounds the annular projection 23 which constitutes an insertion portion along an inner surface of the skirt 33 in the inner volume V3 of the cover 3. The annular projection 23 is inserted linearly in the tubular/skirt portion 33 which is provided with at least one notch or window 300 for retaining the reentrant portions of the locking member 4. This retention is done near the same height as the external grooves 12 of the projection 23, for the nested position of the cover 3.

In cross-section and as can be seen in particular in FIG. 3, the locking member 4 may have an inner circumference which generally follows the geometry, here generally circular, of the lateral outer surface of the cover 3 with possibly a radial offset outward. However, in several areas, the locking member 4 has engagement segments 4a, 4b, 4c which are offset inward and can come into contact against a retaining surface S32 located on the inner side relative to the skirt 33.

In this example, at least one of the engagement segments 4a, 4b, 4e may be delimited between two portions with reentrant angle (on the circumference of the member 4) or portions similarly folded inward. Here, as can be seen in FIG. 3, a staple structure is provided with an intermediate portion 40 which constitutes or includes a first engagement segment 4a which can enter into one of the external grooves 12 or hollow relief similar to the annular projection 23. The two branches B1, B2 connected to this intermediate portion 40 could be arched and each has another engagement segment, for example also delimited by two reentrant angles. A first engagement segment 4a can thus be provided located opposite the free ends 41, 42 of the staple forming the locking member 4, and second and third segments 4b, 4c participating in the tightening action with tightening around the annular projection 23.

The insertion of engagement segments 4a, 4b, 4c may be limited in order to correspond to a radial overlap extension of less the 4 or 5 mm. For example, a radial coverage of order 2 mm for each engagement segment, relative to a corresponding axial stop surface of the connection element 2 may be sufficient while also allowing disengagement by elastic deformation combined, if necessary, with a dilation effect in case of hot gases HG present in the PC portion of the channel C2. These values may however vary as a function of the structure and size of the locking member 4, 104.

Since the grooves 12 here correspond to axially delimited outer notches between two rims (axial), on the outer surface of the annular projection 23, a holding edge BP is formed which forms an axial stop for opposing the withdrawal of the cover 3 nested around this projection 23 when all the engagement segments 4a, 4b, 4c are inserted under the one or more corresponding holding edges BP. The locking member 4 may have a strand structure of metal or any other material with stiffness comparable to steel, such that it is elastically deformable so as to be able to have a variation in the separation between the branches B1, B2, and therefore a variation in the tightening configuration thereof, which may be looser here, preferably without as such disengaging from the support/attachment region.

In this second embodiment, the withdrawal of the cover 3 may happen once the unlocking member 4 starts to deform radially outward, typically with the supply of pressurized gas resulting from tearing of the membrane 5. The deformation is achieved by separating (spreading) the two tightening branches of the staple from each other (possibly with an enlargement of the separation/opening as in the case of FIG. 6).

In other words, the locking member 4 is deformable and may switch from a tightening configuration to a looser configuration so that one or more engagement segments 4a, 4b, 4c are no longer in contact with the connection element 2 while remaining supported by the cover 3. In case of overpressure under the cover 3, in the portion PC, it is understood that the traction force concentrated near the contact zone with the one or more holding edges BP is going to exceed a threshold for overcoming the elastic restoring force exerted inward on these engagement segments 4a, such that a spreading (see FIG. 6) of the branches B1, B2 will be obtained by simple deformation of the member 4, which is more easily deformable than the stiff body 20 or the stiff cover 3.

Although this example shows a generally annular support region belonging to the cover 3 at least partially openworked and hollowed for receiving engagement segments 4a, 4b, 4c for the member which surrounds this support region, other implementations are allowed for the support function of the locking member. For example, all or part of the support region may be formed in an inner volume V3 of the cover 3 or in some variants an interlacing between the cover 3 and one or more support members may be provided, while using radial outward mobile engagement segments.

The annular structure of this member 4, here not closed with two branches B1, B2 having terminations or free ends 41, 42, allows placing the locking member 4 around the cover 3 without interfering with the exhaust path along the surfaces F21 and F22 for the gases having passed through the membrane 5.

Independently of the geometry or relative position of the one or more locking parts relative to a wall of the cover 3, the locking member 4 may be located axially farther from the opening O than the support region is where the member 4 is mounted.

In a variant, two locking members separated from each other may participate in the tightening effect. For example, each of the two members may have a radial travel, because of an elastic deformation, relative to a pivot zone where the member is secured to the cover 3. For example, there may be two branches B1, B2 made in the form of separated locking parts, without shared intermediate part 40.

The nesting of the cover 3 may be done along the nesting direction D1, possibly with a relative rotation between the cover 3 and the insertion portion 23 at least at the beginning of guiding. Not having rotational indexing may constitute an advantage during assembly, in view of increasing the production rate of preassembled ventilation units.

The cover 3 is then axially locked:
without being able to further slide because of the annular stop/shoulder surface which is already in contact with the tabs L3 of the cover 3 or in contact with an edge of the skirt 33 by possible external ramps R2 provided on the shoulder; and
without being able to rise up considering the restoring force which keeps the engagement segments in the groove, under the lower surface of the reliefs R3 or axial stop surfaces 32.

Of course, the number of engagement/contact segments may vary according to the geometry selected for the locking member 4, 104 while keeping a tightening function, preferably with reversible deformation properties allowing in easier radial loosening for the nesting, a radial tightening for the locking and again a radial loosening for unlocking.

Instead and in place of a staple structure, in a single part, equivalent locking means can be implemented resulting from an assembly of complementary parts or also using two branches B1, B2 separated and stiffly connected to the skirt 33 or another support region in the cover 3, so as to be able to present a radial travel in case of urging/overpressure under the cover beyond a threshold. More generally, the locking member 4, 104 may have any structure with two parts, halves or branches B1, B2 while providing a restoring force on at least one of the branches towards the other.

Of course, the locking member 4, 104 may have different geometries, while typically being implemented in a single part. A wire staple structure or locking circlip may be suitable for forming a locking member which has a tightened region between two branches B1, B2 or halves with or without complementary tightening by at least one intermediate portion 40 of the member 4 which is located opposite from the ends 41, 42 of the part.

The lifting of the cover 3, which may be seen in FIG. 6 for example, is allowed under the combined effect of the pressure increase and the deformation/separation of the halves or branches B1, B2. The more the pressure increases, the more the force also increases near the engagement segments 4a, 4b, 4c, 104a which the axial force may take up.

Here, since the staple or member 4 is flexible, as the pressure increases it is no longer going to hook/insert under the holding rim BP: the cover 3 is therefore going to be ejected along the direction D2. The arrangement 1 thus constitutes a device for connection to free air which allows the ejection of the cover 3 only under specific conditions, where simple vibrations are not sufficient to deform all the engagement segments 4a, 4b, 4c in a centrifugal direction, or at least sufficiently separate the branches B1, B2. The same principle could apply with other forms or arrangements for the locking member, which may be placed for example in the inner volume V3 as in the first embodiment.

The present disclosure is not limited to the embodiments described above, only as examples, but it encompasses all variants which a person skilled in the art in the context of the desired protection could conceive.

For example, several membranes may be provided in the channel C2, placed in series or in parallel. In an option with partitioning of the channel C2 into two subconduits each associated with one membrane, it is understood that it is possible to pierce only one of the membranes or both of them simultaneously, according to the need. Once the piercing or similar action of creating a non-filtering passage is done, gases are going to be able to bypass such a filtration part, by passage or opening path 05: the ventilation in the exiting direction is then improved by reduction of loss of load, and is again further increased if the overpressure reaches or exceeds the threshold allowing the forming the locking member 4 or 104.

Further, the expression, battery compartment, must be understood in a general meaning, the compartment may include one or more groups of rechargeable batteries able to provide energy which can be used under any form for conversion to electric energy.

The battery compartment P including the opening O may have any orientation. Even though the nonlimiting example from FIG. 5 corresponds to an orientation of this plate P in a generally horizontal plane for arranging a cover 3 axially covering up (on the top) the connection element 2 such that the axis X is here vertical, other arrangements are allowed, in particular with a ventilation unit mounted laterally on the battery compartment.

1-14. (canceled)

15. An arrangement for pressure compensation for battery compartment, where the arrangement comprises:
a connection element configured to be mounted in an opening of the compartment and having an annular body extending around a central axis delimiting a channel for circulation of a gaseous fluid;
a cover for blocking the channel, where the cover is mounted on the annular body by nesting along a direction of getting closer to the base;
a membrane that is gas permeable to retain dust while allowing filtering a gaseous fluid in the channel, where the membrane is deformable with a mobile portion that is movable towards a blocking portion belonging to the cover in response to an overpressure from a side opposite the cover, where a set portion of the channel is axially delimited between the cover and a surface of the membrane facing the cover; and
at least one locking member locking an axial nesting position of the cover for which the cover blocks without sealing an outlet of the channel;
wherein the cover is designed and arranged, in said axial nesting position, for piercing or damaging the membrane when the mobile portion is moved towards the blocking portion beyond a critical movement distance, which allows at least a part of the gaseous flow to pass through the membrane without filtration; and
wherein said at least one locking member, which is engaged against at least one holding edge belonging to the connection element in order to axially retain the cover, is configured to disengage from said holding edge by deformation in case of exceeding an overpressure threshold prevailing in the set portion of the channel and thus unlock the nesting of the cover.

16. The arrangement according to claim 15, wherein the blocking portion extends transversely relative to the central axis, where a linear nesting movement of the cover relative to the connection element is done along a first direction,
wherein the annular body has an annular base allowing an axial retention against the compartment, directly or via an annular sealing element, where the annular body has a free edge distal from the compartment, opposite the base,
wherein in the axial nesting position, the blocking wall is axially near the free edge or placed on the free edge, and
wherein the unlocking of the nesting by deformation of said locking member allows the cover to be moved by the thrust exerted on the blocking wall along a second direction opposite the first direction, because of which a withdrawal of the blocking wall far from the free edge results.

17. The arrangement according to claim 16, wherein the connection element is made of a single piece and bears an annular sealing element, housed in an inner groove of the base which opens out axially opposite the blocking portion, in order to achieve an annular seal with the compartment.

18. The arrangement according to claim 15, wherein the at least one locking member is distinct from the cover and the connection element, where said at least one locking member surrounds or is surrounded by an overlapping zone between the connection element and the cover.

19. The arrangement according to claim 15, wherein the at least one locking member extends annularly around the central axis, where the locking member consists of a piece deformable by modification of the spacing between two ends of this piece which are neighbors to each other.

20. The arrangement according to claim 15, wherein the at least one locking member is a locking member supported by the cover.

21. The arrangement according to claim 20, wherein the locking member is supported by a tubular portion of the cover and adapted to engage against at least one holding edge formed in an insertion portion belonging to the annular body, in order to lock the axial nesting position of the cover, where this locking is implementable only in an overlapping position of the tubular portion around the insertion portion.

22. The arrangement according to claim 21, wherein the locking member extends or is inserted in at least one empty space or window of the tubular portion, in order to exert a tightening action against the insertion portion, where the locking member is elastically deformable by radial outward deformation.

23. The arrangement according to claim 20, wherein the cover further has a support part connected to the blocking portion, with the support part comprises:
a ring or peripheral portion laid out for bearing the locking member which extends annularly by following circumferentially along an inner surface of the annular body;
an end projecting axially relative to the ring, by projecting along a direction going opposite the blocking portion, where the end has at least one piercing point or member for perforating the mobile portion of the membrane.

24. The arrangement according to claim 23, wherein the at least one locking member serves to retain the cover axially in the nested position by coming to engage against at least one inner relief included in said inner surface of the annular body, which is made of a single piece of stiff material.

25. The arrangement according to claim 15, wherein the annular body is configured to be inserted partially in an annular space which is provided in an inner volume of the cover, by inserting it between a skirt of the cover and a central piercing stem belonging to the cover.

26. An assembly method for assembling the arrangement according to claim 15, which is an arrangement for pressure compensation for a battery compartment, by using a membrane and a connection element that is configured to be mounted in an opening of the battery compartment, with the connection element having an annular body extending around a central axis and the delimiting a channel for circulation of a gaseous fluid, where the arrangement, mounted on the annular body by nesting, comprises a cover for blocking the channel, the cover having a blocking portion extending transversely relative to a nesting direction of the cover, wherein the method comprises:
arranging the membrane transversely in the annular body in order to allow a filtration of the gaseous flow moving in the channel, the membrane being gas permeable and configured to retain dust;
mounting the cover on the annular body by nesting towards the membrane along the nesting direction, such that the blocking portion covers an axial outlet of the channel and covers the membrane, while a pointed or cutting end included in the cover is placed facing the membrane, where a set portion of the channel is axially delimited between the cover and a surface of the membrane facing the cover;
locking the axial nesting position of the cover by at least one locking member; where the at least one locking member is placed on the cover before nesting, and where the nesting is done such that the at least one locking member:
comes to engage against at least one holding edge formed laterally on the annular body; and
remains deformable in order to allow unlocking the nesting of the cover when the overpressure on the gaseous fluid side present in the set portion of the evacuation channel exceeds a threshold; and
wherein the membrane is deformable and provided with a mobile portion that is movable towards the blocking portion in response to an overpressure from a side opposite the cover.

27. The assembly method according to claim 26, wherein the at least one locking member is a single piece placed on the cover before nesting, by spreading two opposite ends of said piece that is deformable, before tightening an annular support region belonging to the cover.

28. The arrangement according to claim 15, wherein the at least one locking member consists of a single elastically deformable piece.

29. The arrangement according to claim 15, wherein the cover has a blocking portion without any opening, the cover being configured to allow an escape of air only around an external skirt of the cover.
